(19) United States
(12) Patent Application Publication
(10) Pub. No.: US 2003/0017357 A1
(43) Pub. Date: Jan. 23, 2003

(54) Component of printed circuit boards

(75) Inventors: R. Richard Steiner, University Heights, OH (US); Robert E. Batson, Newington, CT (US)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: Gould Electronics Inc.

(21) Appl. No.: 09/905,557

(22) Filed: Jul. 13, 2001

(51) Int. Cl. B32B 15/08; B32B 3/02

(52) U.S. Cl. 428/626; 428/192

(57) ABSTRACT

A component for use in manufacturing articles such as printed circuit boards having a sheet of copper foil and a metal sheet. One surface of each of the copper sheet and the metal sheet are essentially uncontaminated and engageable with each other at an interface. The copper sheet and the metal sheet are maintained together to define an unjoined and substantially uncontaminated central zone inwardly of the edges of the sheets. A bond is formed between the copper sheet and the metallic sheet along the peripheral edges thereof. The bond has sufficient adhesive strength to maintain the sheets together during manual handling of the component at room temperatures. The bond is temperature-sensitive, wherein the bond deteriorates when exposed to temperatures in excess of about 180° F. (about 82° C.).

### FIELD OF THE INVENTION

The present invention relates generally to printed circuits, and more particularly, to components used in the manufacturing of printed circuit boards and other articles.

### BACKGROUND OF THE INVENTION

In the manufacture of printed circuit boards, sheets of copper foil are typically bonded with a dielectric layer of a partially cured epoxy resin containing woven glass fiber (such a dielectric layer is conventionally referred to as a “prepreg”). In the manufacture of copper clad laminates, sheets of copper foil are typically bonded to another layer of foil. In both processes, the copper foil is etched to produce conductive paths. In such processes, it is extremely important to avoid contamination of the copper foil sheets in that any foreign matter contacting the copper foil, such as resin dust, fiberglass fibers, hair, grease, oil or the like, may result in dots, dents, deposits or pits on the copper foil that can adversely affect the formation of the conductive paths forming the printed circuits.

Copper foil is conventionally formed by an electrodeposition process or by a rolling process. Following the production of the copper foil, it is known to position a clean, metallic substrate to one, clean side of the copper foil to protect that side of the copper foil from contamination during subsequent handling and shipping. The protected side of the copper foil is typically the side used to form the conductive pathways, while the exposed side of the foil is typically the side that is attached to a prepreg or bonded to another layer of copper foil. The protective metallic substrate remains adjacent to the copper foil as it is attached to the prepreg or bonded to the other layer of copper foil. The protective metallic substrate is subsequently removed and discarded (or recycled) to expose the protected, uncontaminated side of the foil for processing to form the conductive pathways.

The component may also be constructed of two sheets of copper foil that each constitutes a functional element in a finished printed circuit board and a single, metallic substrate that constitutes a discardable element. U.S. Pat. No. 5,153,050 to Johnston discloses a copper/aluminum/copper component wherein the shiny side of copper foils are disposed adjacent to an aluminum substrate. U.S. Pat. No. 5,674,596 to Johnston further discloses copper foil(s) adjacent to a metallic substrate, such as a steel or a stainless steel substrate. U.S. Pat. No. 5,512,381 to Konicek et al. discloses positioning copper foil(s) adjacent to a copper substrate.

It is known to use a band of flexible adhesive to join the uncontaminated sheet(s) of copper foil and metallic substrate at their borders to define the substantially uncontaminated central zone interior to the edges of the respective sheets. It is also known to maintain the relationship between the sheet(s) of copper and the metallic substrate by mechanical means such as by spot welding or by crimping the sheets together.

While components of the type heretofore described have found advantageous application in the manufacture of printed circuit boards, problems sometimes arise during the lamination process when the sheet of copper foil is being bonded to the dielectric substrate, i.e., the prepreg. Warping or twisting may appear in the resultant laminated structure, i.e., the copper foil that is affixed to the dielectric substrate, as a result of internal stress created in such structure during the laminating process.

In this respect, a number of factors contribute to the internal stresses created in the laminated structure and the deformation thereof. For example, the design of the board, namely, the thickness of the resultant laminated structure, is influential in the amount of internal stress the structure can withstand without warping or twisting. In this respect, thinner, laminated structures are more susceptible to twisting and warping. The bonding materials used in the prepreg layer also produce stresses in the resultant laminate during heating and cooling. Still further, the laminating cycle is influential in the amount of stress created within the resultant laminated structure.

In the context of the present invention, the composition of the metallic substrate also contributes to the stress induced in the resultant laminated structure. In this respect, it is almost impossible to perfectly match the coefficient of thermal expansion of the copper-clad structure with the metallic support substrate. As a result, any mismatch in the coefficient of thermal expansion will create stresses during the heating and cooling cycles of the laminating process that are transferred through the bonding means into the copper foil and resultant laminated structure.

The present invention overcomes the problem of stresses transferred through the attachment means, and provides a copper/metal component for forming printed circuit boards and the like, wherein the bonds securing a copper sheet to a metal sheet dissipate during a laminating process to release one sheet from the other.

### SUMMARY OF THE INVENTION

In accordance with a preferred embodiment of the present invention, there is provided a component for use in manufacturing articles such as printed circuit boards and copper clad laminates. The component has a sheet of copper foil, which in a finished printed circuit board or copper clad laminate, constitutes a functional element, and a metal sheet which constitutes a discardable element. A surface of each of the copper sheet and the metal sheet is essentially uncontaminated and engageable with each other at an interface. The copper sheet and the metal sheet are maintained together to define an unjoined and substantially uncontaminated central zone inwardly of the edges of the sheets. A bond is formed between the copper sheet and the metallic sheet along the peripheral edges thereof. The bond has sufficient strength to maintain the sheets together during manual handling of the component at room temperatures. The bond is temperature-sensitive, wherein the bond deteriorates when exposed to temperatures in excess of about 180° F. (about 82° C.).

It is an object of the present invention to provide a component having a copper sheet for use in manufacturing articles, such as printed circuit boards, and a metallic substrate to protect a surface of the copper sheet before and during a manufacturing process.

It is another object of the present invention to provide a component as described above, wherein the metallic substrate is a relatively low cost, discardable element.

It is another object of the present invention to provide a component as described above, wherein the copper sheet is adapted to be laminated to a dielectric layer.

It is another object of the present invention to provide a component as described above, wherein the metallic substrate is bonded to the copper sheet at its peripheral edges, and said bond dissipates during a laminating process.

It is another object of the present invention to provide a component as described above, wherein the metallic substrate is bonded to the copper sheet by the use of an adhesive at its peripheral edges, and the adhesive deteriorates due to elevated temperature exposure during a laminating process.

These and other objects will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a plan view of a component for use in the manufacturing of printed circuit boards illustrating an embodiment of the present invention;

FIG. 2 is an enlarged, sectioned perspective view taken along lines 2-2 of FIG. 1;

FIG. 3 is an enlarged, sectioned perspective view of a component for use in manufacturing printed circuit boards, illustrating another embodiment of the present invention;

FIG. 4 is an enlarged, sectioned perspective view of a component for use in manufacturing printed circuit boards, illustrating yet another embodiment of the present invention;

FIG. 5 is a sectional view of the component shown in FIG. 4 illustrating separation of a sheet of copper foil from a metallic substrate.

### DETAILED DESCRIPTION OF PREFERRED EMBODIMENT

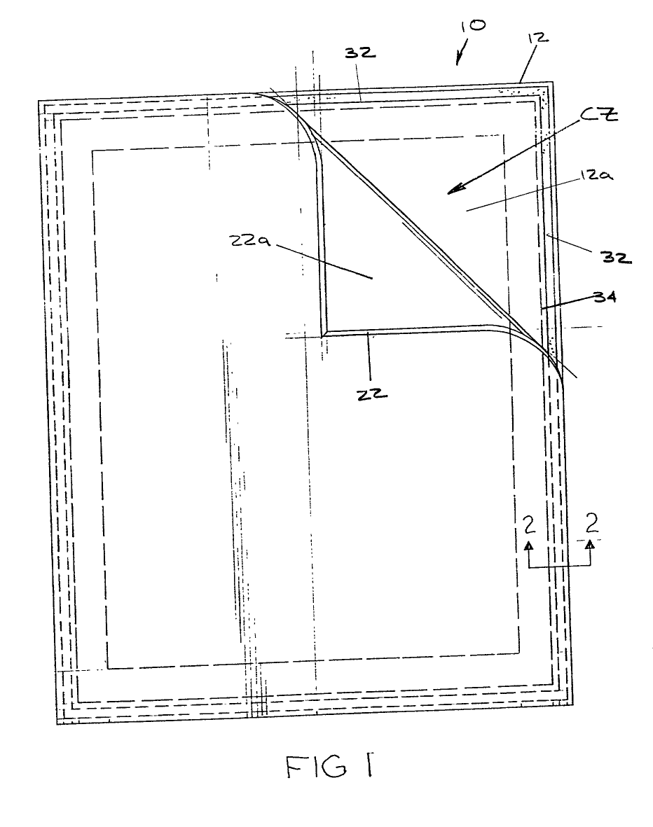

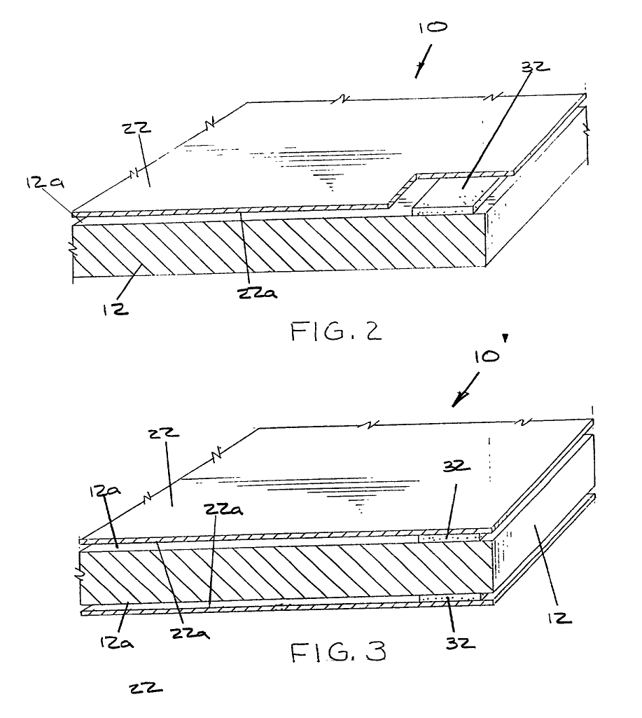

Referring now to the drawings wherein the showings are for the purpose of illustrating the preferred embodiment of the invention only, and not for the purpose of limiting same, FIGS. 1 and 2 show a component 10 for use in forming manufacturing articles such as printed circuit boards, illustrating a preferred embodiment of the present invention. The present invention relates to components of the type disclosed in U.S. Pat. Nos. 5,153,050; 5,674,596; 5,725,937; 5,942,315; 5,951,803 and 6,048,430 all to Johnston and entitled COMPONENT FOR PRINTED CIRCUIT BOARDS, the disclosures of which are expressly incorporated herein by reference. Broadly stated, component 10 is comprised of a metallic substrate 12 having at least one sheet 22 of copper foil attached to one side thereof.

Substrate 12 is a metallic sheet that may be formed of a number of different metals or metal alloys, such as by way of example but not limitation, aluminum, stainless steel, copper or carbon steel. Carbon steel sheets may have an outer coating (not shown) of an inert metal such as nickel, copper, cobalt, brass, chromium, antimony, cadmium and combinations thereof, to prevent an interaction between substrate 12 and sheets 22. Substrate 12 preferably has a thickness between about 0.05 mm (0.002 inches) to about 2.00 mm (0.079 inches), and more preferably, has a thickness between about 0.25 mm (0.010 inches) and about 0.50 mm (0.020 inches).

In a preferred embodiment, substrate 12 is an aluminum sheet of commercial grade aluminum having a thickness between about 0.25 mm and about 0.50 mm. Substrate 12 has an uncontaminated surface 12a.

Sheet 22 of copper foil may be made using one of two techniques. Wrought or rolled copper foil is produced by mechanically reducing the thickness of a copper or copper alloy strip or ingot by a process such as rolling. Electrodeposited foil is produced by electrolytically depositing copper atoms on a rotating cathode drum and then peeling the deposited foil from the cathode drum. Electrodeposited copper foils find advantageous application with the present invention. Copper foils typically have nominal thicknesses ranging from about 0.005 mm (0.0002 inches) to about 0.50 mm (0.02 inches). Copper foil thickness is sometimes expressed in terms of weight, and typically the foils of the present invention have weights or thicknesses ranging from about ⅛ to about 14 oz. per square foot. Especially useful in forming printed circuit boards are copper foils having weights of ⅛, ⅓, ½, 1 or 2 oz. per square foot.

Copper foils produced by an electrodeposition process have a smoother, shiny (drum) side and a rougher matte (copper deposit growth front) side, and are conventionally referred to as “base foil.” It is known to treat base foil to produce micronodules on the matte side thereof. Such treated foils are referred to as “treated copper foil.” The term “reverse treated copper foil” is conventionally used to refer to a copper foil that is treated to produce micronodules of copper on the shiny side of the foil. “Double treated copper foil” is copper foil that is treated to produce micronodules on both sides of the foil. All of the foregoing types of foils may find advantageous application with this invention. Sheet 22 has an uncontaminated surface 22a.

In the embodiment shown in FIGS. 1 and 2, a band 32 of flexible adhesive extends around the periphery of component 10 at or near the border of substrate 12 to join uncontaminated surfaces 12a and 22a of substrate 12 and copper foil 22 together at their borders. Since the contacting surfaces are clean, or at least as clean as possible, adhesive band 32 creates a substantially uncontaminated central zone (CZ) interior of the edges of the sheets. The central zone (CZ) is unjoined at the interface. Adhesive band 32 is located in an adhesive application zone, designated 34 in the drawings. Zone 34 is typically from 0.10 to 1 inch wide depending upon the article to be formed using component 10.

FIGS. 1 and 2 show an embodiment of the present invention, wherein a sheet 22 of copper foil is attached to one side of substrate 12. FIG. 3 illustrates another embodiment of the present invention, wherein substrate 12 has two, substantially uncontaminated surfaces 12a, one on each side of substrate 12, and two sheets 22 of copper foil attached to substrate 12 by a band 32 of flexible adhesive.

Adhesive band 32 forms a bond between sheet 22 and metallic substrate 12. In one embodiment, the adhesive used to form band 32 is preferably formulated to be fast curing and controlled adhesion by being highly plasticized material. The adhesive is preferably applied as a bead or in drops in sufficient amounts to insure an inward, uncontaminated zone on the copper foil, as is conventionally known. The adhesive may be a liquid, a paste, preformed or in tape form. The adhesive may be applied as a continuous or intermittent bead. If in liquid or paste form, it may be applied directly onto the surface by a dispenser. If a tape or pre-form (B-stage type) is used, it may be rolled on and adhered by a pressure sensitive means or by other contact means. Nominal pressure may be applied to sheet 22 and metallic substrate 12 to facilitate good initial contact and adhesion. The adhesive used to form band 32 preferably has sufficient strength, either by initial tack or developed strength, to maintain the orientation relationship of sheet 22 to metallic substrate 12 during mechanical and/or physical handling at room temperatures.

In accordance with the present invention, the adhesive forming band 32 is formulated to be heat sensitive, wherein after suitable exposure to elevated temperatures, the bond strength between sheet 22 and metallic substrate 12 decreases significantly to allow for release of sheet 22 from substrate 12 without damage to sheet 22. In other words, the adhesive loses all or a majority of its cohesive or adhesive strength between sheet 22 and metallic substrate 12 at the elevated temperatures typically encountered during a laminating process.

The adhesive preferably begins to deteriorate as temperatures in excess of about 180° F. (about 82° C.). As used in the present invention, the term “deteriorates,” when used in the context of a bond, refers to the breakdown of polymer chains (as formed in a thermoplastic or thermoset adhesive) in the adhesive whereby the physical properties of the adhesive, particularly its shear, tensile and adhesive strength, diminish.

Component 10 is adapted for use in a laminating process for forming printed circuit boards or multi-layered laminates. In such a process, component 10 is positioned between two dielectric, glass-impregnated epoxy layers, conventionally referred to as “prepregs.” The entire assembly is subjected to heat and pressure to cure the epoxy resin and bond sheets 22 of copper foil to the prepreg dielectric layers. During the laminating process step, the adhesive that forms band 32 is subjected to temperatures that typically reach about 350° F. (about 177° C.) for periods of time that may range between 30 and 90 minutes. It will, of course, be appreciated by those skilled in the art, that laminating temperatures may exceed 350° F. for certain materials. At this elevated temperature, the adhesive forming band 32 begins to breakdown, wherein it loses some of its shear, tensile and peel strength (i.e., adhesive strength) as the polymer chains of the polymeric adhesive undergo chain scission. In the case of a thermoplastic adhesive, as the chains become shorter, the bond strength is continually reduced until it is finally reduced to zero if time and temperature are sufficient. In the case of a thermoset adhesive, the cross link bonds are broken to affect movement between chains to allow failure to occur. This deterioration of the bond between sheet 22 and substrate 12 prevents transfer of stresses from substrate 12 to the assembly during the heating and cooling of the assembly, thereby reducing the likelihood of internal stresses being formed in the resultant laminated structure. By reducing the stress exerted on sheets 22 of copper foil, the likelihood of bowing or twisting of sheets 22 of copper foil is reduced.

The following Examples are provided for purposes of illustrating the invention. Unless otherwise indicated, in the following Examples, as well as throughout the specification and claims, all parts and percentages are by weight and all temperatures are in degrees Celsius.

### EXAMPLE I

### Thermoplastic Adhesive Composition

| INGREDIENTS | CONCENTRATION (%) |
|---|---|
| Ethyl Cyanoacrylate | 50-80 |
| Flexiblizing Agent | 20-48 |
| Thixotropic Agents | 1-6 |
| Stabilizers | 0.05-0.10 |

Example I is a cyanoacrylate adhesive manufactured by Advanced Adhesive Systems, Inc. of Newington, Conn., under the product designation number 17070B. It should be noted that the foregoing formulation lists only active or hazardous components in reportable concentrations. Dyes and other fillers are not listed.

### EXAMPLE II

### Adhesive Composition

| INGREDIENTS | CONCENTRATION (%) |
|---|---|
| Ethyl Cyanoacrylate | 50-80 |
| Poly (methyl methacrylate) | 5-10 |
| Fumed Silica, amorphous treated | 4-7 |
| Hydroquinone | 0.1-0.3 |
| Dibutylphthalate | 20-48 |
| Stabilizers | 0.01-0.10 |

Example II is a cyanoacrylate adhesive manufactured and sold by Advanced Adhesive Systems, Inc. of Newington, Conn., under the product designation number 17070D. The adhesive of Example II found advantageous application with the present invention.

While ethyl cyanoacrylate is used as the major constituent in the adhesives set forth in Example I and Example II, it is contemplated that other alkyl cyanoacrylates, such as methyl, butyl, octyl, methoxy ethyl cyanoacrylate, or combinations of such cyanoacrylates may be used to form an adhesive for use in the present invention. In this respect, aromatic or alkyl cyanoacrylates, or a combination thereof, may find advantageous application with the present invention. Moreover, other adhesive technologies, such as anaerobics, epoxies, urethanes, silicones, acrylics, including methacrylates or combinations of such adhesives, may find advantageous application in the present invention if formulated properly to allow for a reduction in bond strength during exposure to elevated temperatures during processing and formulation.

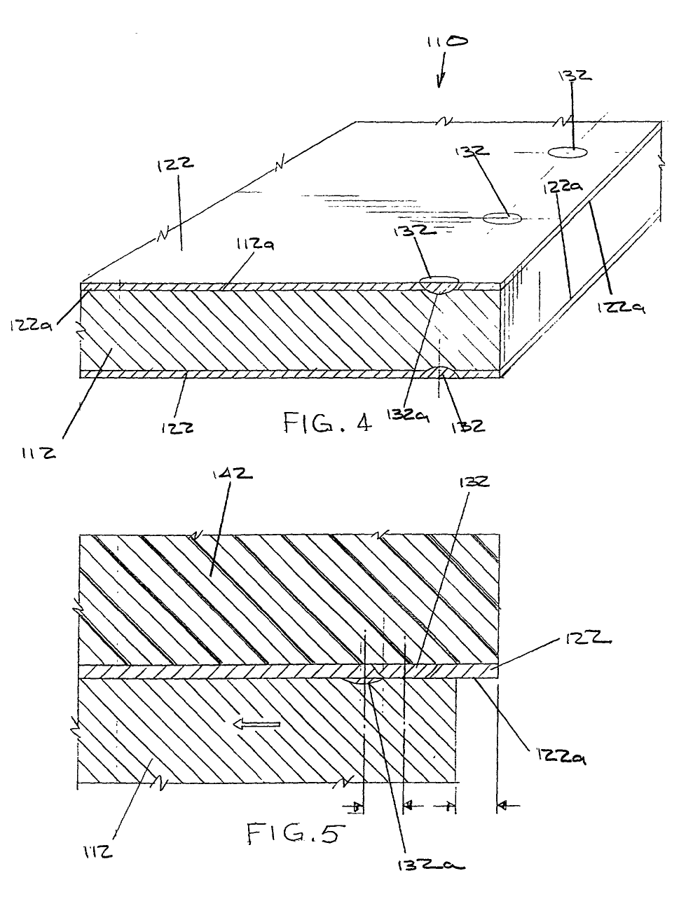

The present invention has heretofore been described with respect to an adhesive bond for attaching sheet 22 to substrate 12. A mechanical bond that deteriorates upon exposure to high shear stresses created during a lamination process may also be used. FIGS. 4 and 5 show a component 110 comprised of a substrate 112 formed of a metallic discardable material and two sheets 122 of copper foil, as heretofore described. Substrate 112 is preferably formed of the same material as heretofore described with respect to substrate 12. Substrate 112 has two, essentially uncontaminated surfaces 112a. Sheets 122 are copper foils of the type heretofore described. Each sheet 122 has a substantially uncontaminated surface 122a.

In the embodiment shown in FIGS. 4 and 5, a mechanical bond attaches sheet 122 and substrate 112 to each other. The mechanical bond is a plurality of weld areas 132 that are disposed along the edge of sheet 122 and substrate 112. As best seen in FIG. 4, weld areas 132 are dimensioned such that only a small portion 132a of weld area 132 exists at the interface of sheet 122 and substrate 112, and penetrates into substrate 112. Weld areas 132 may be formed by conventional spot welding, or other known welding techniques. By controlling the welding operation and parameters, such as the depth of penetration of weld areas 132 into substrate 112, the size of weld areas 132, the number of weld areas 132, etc., the strength of the resulting weld areas may be adapted to provide a low shear joint or bond that deteriorates at a certain shear stress is provided. In this respect as illustrated in FIG. 5, and as discussed in the Background of the Invention, during a laminating process, both sheet 122 and metallic substrate 112 expand as a result of the heat applied thereto. Heat and pressure are applied to component 110 to cure an epoxy (not shown) that ultimately bonds each sheet 122 to an adjacent prepreg layer, designated 142. This expansion of the respective layers causes weld areas 132 to breakdown and separate as one layer expands to a greater extent than the other. The difference in the coefficient of thermal expansion of sheet 122 and metallic substrate 112 may create sufficient shear stresses to cause weld areas 132 to breakaway during the heating cycle. It is believed, however, it is during the cooling cycle, wherein sheet 112 of copper foil is attached and cured to its adjacent, dielectric prepreg layer 142, that the metallic substrate 112 shrinks considerably relative to sheet 122, resulting in weld areas 132 breaking away. In other words, metallic substrate 112 shrinks relative to the stationary sheet 122 that is adhered to the dielectric prepreg layer 142, as schematically illustrated in FIG. 5, and causes weld areas 132 to break under the shear stresses exerted thereon. FIGS. 4 and 5 thus illustrate how the concept of the present invention may be incorporated into a mechanical bond.

The foregoing description is a specific embodiment of the present invention. It should be appreciated that this embodiment is described for purposes of illustration only, and that numerous alterations and modifications may be practiced by those skilled in the art without departing from the spirit and scope of the invention. In this respect, other adhesive technologies which would allow release as a result of their inherent strength or from exposure to heat is contemplated. It is intended that all such modifications and alterations be included insofar as they come within the scope of the invention as claimed or the equivalents thereof.

Having described the invention, the following is claimed:

1. In a component for use in manufacturing articles such as printed circuit boards and copper clad laminates, said component having a sheet of copper foil, which in a finished printed circuit board or copper clad laminate, constitutes a functional element, and a metal sheet which constitutes a discardable element, one surface of each of the copper sheet and the metal sheet being essentially uncontaminated and engageable with each other at an interface, said copper sheet and said metal sheet being maintained together to define an unjoined and substantially uncontaminated central zone inwardly of the edges of the sheets, the improvement comprising:
a bond formed between said copper sheet and said metallic sheet along the peripheral edges thereof, said bond having sufficient adhesion strength to maintain said sheets together during manual handling of said component at room temperatures, said bond being temperature-sensitive, wherein said bond deteriorates when exposed to temperatures in excess of about 180° F. (about 82° C.).

2. A component as defined in claim 1, wherein said substrate is joined to said copper foil by an adhesive.

3. A component as defined in claim 2, wherein an adhesive is disposed between said sheet of metal and said sheet of copper.

4. A component as defined in claim 2, wherein said sheet of copper foil is rolled copper foil.

5. A component as defined in claim 2, wherein said adhesive is comprised of a material selected from the group consisting of an aromatic cyanoacrylate, an alkyl cyanoacrylate and combinations thereof.

6. A component as defined in claim 2, wherein said sheet of copper foil is electrodeposited copper foil.

7. A component as defined in claim 6, wherein said copper foil is selected from the group consisting of base copper foil, treated copper foil, reverse treated copper foil and double treated copper foil.

8. In a component for use in manufacturing articles such as printed circuit boards and copper clad laminates, said component having a sheet of copper foil, which in a finished printed circuit board or copper clad laminate, constitutes a functional element, and a metal sheet which constitutes a discardable element, one surface of each of the copper sheet and the metal sheet being essentially uncontaminated and engageable with each other at an interface, said copper sheet and said metal sheet being maintained together to define an unjoined and substantially uncontaminated central zone inwardly of the edges of the sheets by a bead of adhesive engaging at least said sheet of copper foil, the improvement comprising:
said bead of adhesive having a first adhesive state when maintained at temperatures below a laminating temperature and a second adhesive state when maintained for a period of time at said laminating temperature, said bead of adhesive having less adhesion or cohesive strength in said second adhesive state than in said first adhesive state.

9. A component as defined in claim 8, wherein said adhesive is comprised of a material selected from the group consisting of an aromatic cyanoacrylate, an alkyl cyanoacrylate and combinations thereof.

10. A component as defined in claim 8, wherein said adhesive is comprised of alkyl cyanoacrylate.

11. A component as defined in claim 10, wherein said adhesive includes a cyanoacrylate selected from the group consisting of methyl, ethyl cyanoacrylate, butyl cyanoacrylate, octyl cyanoacrylate, methoxy ethyl cyanoacrylate and combinations thereof.

12. A component as defined in claim 8, wherein said adhesive is comprised of: 50-80% concentration of ethyl cyanoacrylate, 20-48% concentration of flexiblizing agent, 1-6% concentration of thixotropic agents and 0.05-0.10% concentration of stabilizers.

13. A component as defined in claim 8, wherein said adhesive is comprised of 50-80% concentration of ethyl cyanoacrylate, 5-10% concentration of poly (methyl methacrylate), 4-7% concentration of amorphous treated fumed silica, 0.1-0.3% concentration of hydroquinone, 20-48% concentration of dibutylphthalate and 0.01 to 0.10% concentration of stabilizers.

14. In a component for use in manufacturing articles such as printed circuit boards and copper clad laminates, said component having a sheet of copper foil, which in a finished printed circuit board or copper clad laminate, constitutes a functional element, and a metal sheet which constitutes a discardable element, one surface of each of the copper sheet and the metal sheet being essentially uncontaminated and engageable with each other at an interface, said copper sheet and said metal sheet being maintained together to define an unjoined and substantially uncontaminated central zone inwardly of the edges of the sheets, the improvement comprising:
said copper sheet being attached to said metallic sheet along the peripheral edges thereof, by a bond operable to maintain attachment of said copper sheet to said metallic substrate at room temperature, but operable to release when subjected to elevated temperatures during a lamination process.
